(19) United States
(12) Patent Application Publication
(10) Pub. No.: US 2017/0255326 A1
(43) Pub. Date: Sep. 7, 2017

(54) VEHICULAR TOUCH PAD AND VEHICULAR INPUT INTERFACE

(71) Applicant: DENSO CORPORATION, Kariya-city, Aichi-pref. (JP)

(72) Inventors: Shigeaki NISHIHASHI, Kariya-city (JP); Tsuneo UCHIDA, Kariya-city (JP)

(21) Appl. No.: 15/503,834

(22) PCT Filed: Aug. 6, 2015
(86) PCT No.: PCT/JP2015/003963

§ 371 Date: Feb. 14, 2017

(30) Foreign Application Priority Data
Aug. 27, 2014 (JP) 2014-173060

(51) Int. Cl. G06F 3/041; B60K 35/00; G06F 3/0484; G06F 3/0481; G06F 3/044; G06F 3/0482

(52) U.S. Cl. CPC G06F 3/0416; G06F 3/044; G06F 3/0482; G06F 3/04847; G06F 3/04817; B60K 35/00; G06F 2203/04101; B60K 2350/1028; B60K 2350/352; B60K 2350/908

(57) ABSTRACT

A vehicular touch pad disposed in a vehicle compartment includes a design panel configuring an outer surface, a capacitive sensor panel disposed below the design panel and including at least two planes having different distances to the design panel, and an arithmetic device. The arithmetic device estimates a proximity degree between a manipulation body and the design panel and a position of the manipulation body relative to one plane having a shorter linear distance to the design panel based on an electric charge stored between the one plane and the manipulation body. The arithmetic device further determines whether the manipulation body touches the design panel based on an electric charge stored between a different plane having a longer linear distance to the design panel and the manipulation body.

### CROSS REFERENCE TO RELATED APPLICATION

This application is based on Japanese Patent Application No. 2014-173060 filed on Aug. 27, 2014, the disclosure of which is incorporated herein by reference.

### TECHNICAL FIELD

The present disclosure relates to a vehicular touch pad which outputs a three-dimensional signal and a vehicular input interface.

### BACKGROUND ART

A vehicular input interface including touch pad that outputs a three-dimensional signal and a display device that displays a variety of modes of a multimedia system on the basis of the three-dimensional signal outputted from the touch pad has been known (for example, Patent Literature 1).

### PRIOR ART LITERATURE

### Patent Literature

[Patent Literature 1] JP 2011-118857 A

### SUMMARY OF INVENTION

It is an object of the present disclosure to provide a vehicular touch pad which includes a capacitive sensor and is capable of detecting a distance to a manipulation body with high accuracy, and it is also an object of the present disclosure to provide a vehicular input interface.

According to a first aspect of the present disclosure, a vehicular touch pad disposed in a vehicle compartment includes a design panel that configures an outer surface, a capacitive sensor panel disposed below the design panel, and an arithmetic device. The capacitive sensor panel includes at least two planes having different distances to the design panel. The arithmetic device estimates a proximity degree between a manipulation body and the design panel and a position of the manipulation body relative to one plane, which is one of the at least two planes included in the capacitive sensor panel and has a shorter linear distance to the design panel, based on an electric charge stored between the one plane and the manipulation body. The arithmetic device further determines whether the manipulation body touches the design panel based on an electric charge stored between a different plane, which is another one of the at least two planes included in the capacitive sensor panel and has a longer linear distance to the design panel, and the manipulation body.

In the above vehicular touch pad, a distance to a manipulation body can be detected with high accuracy with use of a capacitive sensor.

According to a second aspect of the present disclosure, a vehicular input interface for operating an image displayed on a display device disposed in a vehicle compartment includes a touch pad including a design panel and a display control device controlling the image displayed on the display device based on an input from the touch pad. The touch pad further includes a capacitive sensor panel disposed below the design panel and including at least two planes having different distances to the design panel, and an arithmetic device. The arithmetic device, according to an output from the capacitive sensor panel including the at least two planes, estimates a proximity degree between a manipulation body and the design panel, estimates a position of the manipulation body relative to the design panel, and determines whether the manipulation body touches the design panel. The arithmetic device estimates the proximity degree between the manipulation body and the design panel and a position of the manipulation body relative to one plane, which is one of the at least two planes included in the capacitive sensor panel and has a shorter linear distance to the design panel, based on an electric charge stored between the one plane and the manipulation body. The arithmetic device determines whether the manipulation body touches the design panel and estimates a position of the manipulation body relative to a different plane, which is another one of the at least two planes included in the capacitive sensor panel and has a longer linear distance to the design panel, based on an electric charge stored between the manipulation body and the different plane. The display control device operates the image displayed on the display device based on the proximity degree of the manipulation body relative to the design panel and a determination result of whether the manipulation body touches the design panel.

With the above vehicular input interface, advantages similar to the advantages provided by the vehicular touch pad according to the first aspect of the present disclosure can be provided.

### BRIEF DESCRIPTION OF DRAWINGS

The above and other objects, features and advantages of the present invention will become more apparent from the following detailed description made with reference to the accompanying drawings. In the drawings:

FIG. 1 is a diagram illustrating a vehicular touch pad and a vehicular input interface which are arranged in a vehicle compartment according to an embodiment of the present disclosure;

FIG. 2 is a perspective view of the vehicular touch pad according to the embodiment;

FIG. 3 is a perspective view illustrating an internal structure of the vehicular touch pad illustrated in FIG. 2;

FIG. 4 is a cross-sectional view schematically illustrating a detection area defined in the vehicular touch pad illustrated in FIG. 2;

FIG. 5 is a flowchart illustrating a control of an arithmetic device according to the embodiment;

FIG. 6 is a flowchart illustrating a control of a display control device according to the embodiment;

FIG. 7 is a diagram illustrating examples of a display screen of a display device included in the vehicular input interface in two display modes, and a positional relationship between a manipulation body and the touch pad corresponding to the two display modes according to the embodiment; and

FIG. 8 is a diagram illustrating a detection characteristic of a capacitive sensor panel provided by a single plane when detecting the manipulation body.

### EMBODIMENTS FOR CARRYING OUT INVENTION

Hereinafter, embodiments of the present disclosure will be described with reference to the drawings. Meanwhile, since corresponding components of the respective embodiments are denoted by the same reference symbols, the repeated description thereof may be omitted. In the embodiments, when partial portion of a configuration is described, a configuration of the preceding embodiment can be applied to the remaining portion of the configuration. In addition to a combination of configurations explicitly stated in a description of each embodiment, configurations of the multiple embodiments can be partially combined together even if not explicitly stated, if no problem particularly occurs in the combination.

The inventors of the present disclosure have found the following problems in implementation of the above-described touch pad that outputs a three-dimensional signal using a capacitive sensor.

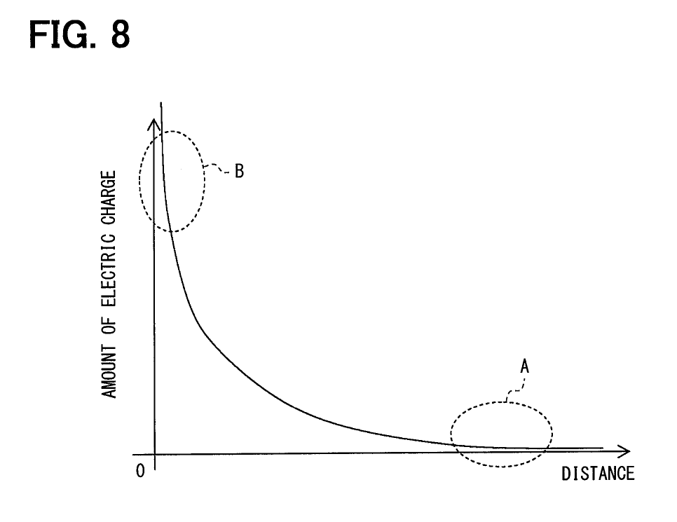

The capacitive sensor estimates a distance between an electrode and a manipulation body according to a magnitude of electric charge stored between a detection electrode and the manipulation body such as a finger to be detected. Because the magnitude of the electric charge stored between the electrode and the manipulation body is inversely proportional to a square of the distance between the electrode and the manipulation body, the amount of stored electric charge comes asymptotically closer to zero as the manipulation body moves more away from the electrode. When the distance between the manipulation body and the electrode is increased, an estimation accuracy of the distance is remarkably decreased (refer to an area A in FIG. 8).

Conversely, when the manipulation body comes remarkably closer to the electrode, the amount of electric charge stored between the manipulation body and the electrode theoretically increases to infinite. In actual use, the stored electric charge does not increase to infinite. Thus, the detection accuracy is not satisfied when the manipulation body is far from or remarkably close to the electrode (refer to an area B in FIG. 8). The present disclosure has been made in view of the above difficulties.

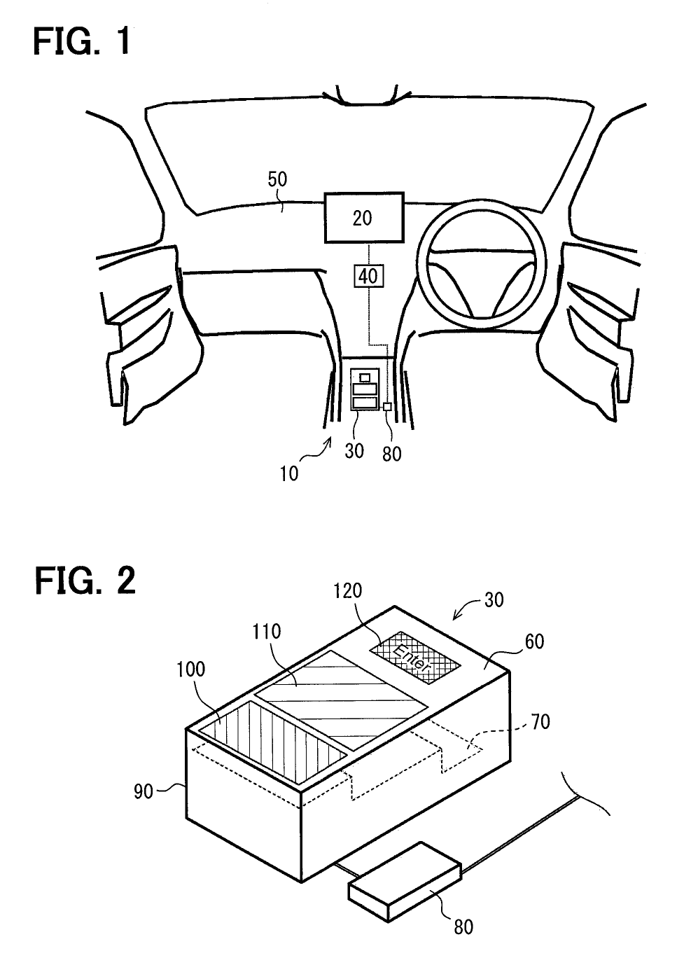

FIG. 1 is a diagram illustrating an arrangement of a vehicular touch pad and a vehicular input interface in a vehicle compartment according to an embodiment of the present disclosure. A vehicular input interface 10 according to the present embodiment is used to operate an image displayed on a display device 20, and includes a vehicular touch pad 30 and a display control device 40.

The display device 20 is a multifunction display disposed approximately in the center of a vehicle instrument panel 50, which is a general-purpose display device that displays manipulation screens of a vehicle air conditioning apparatus, a radio, a navigation apparatus, and an audio, which are not shown. The display device 20 also displays an image from a back camera, and an around view using composite images from multiple cameras.

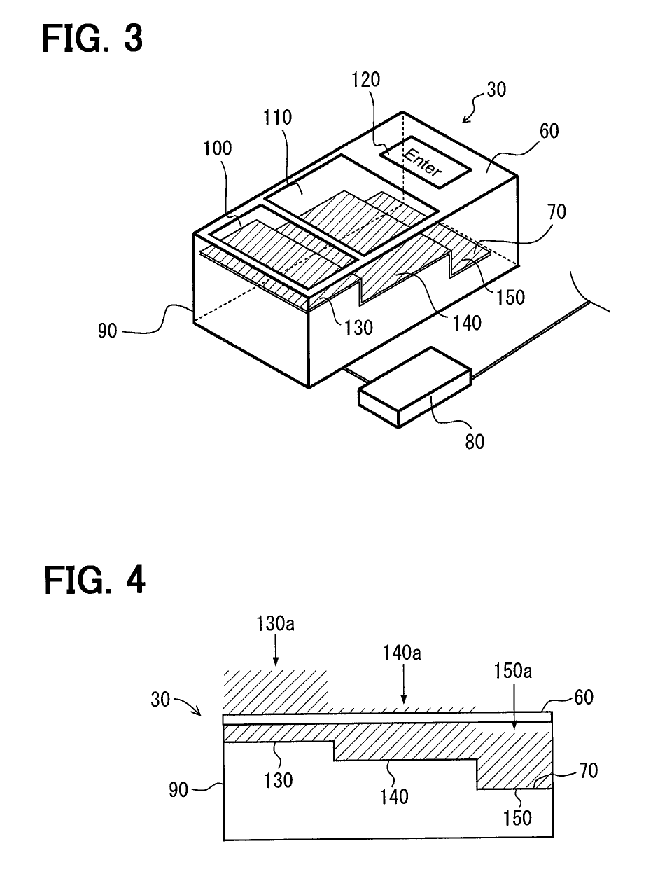

The vehicular touch pad 30 includes an arithmetic device 80, and the arithmetic device 80 reads a signal related to a capacitance from a capacitive sensor panel 70 (refer to FIG. 3) disposed below a design panel 60. Then, the arithmetic device 80 generates a three-dimensional signal according to a predetermined rule to be described later, and outputs the generated signal to the display control device 40.

The display control device 40 switches various manipulation screens from one to another on the basis of the three-dimensional signal from the arithmetic device 80 of the vehicular touch pad 30, and displays, on the display device 20, an image for accepting an input to a function corresponding to the image.

The vehicular touch pad 30 according to the present embodiment is disposed in the vicinity of an armrest (not shown) which is disposed between a driver's seat and a passenger's seat, and the design panel 60 is disposed so that a driver's palm is positioned just on the design panel 60 when the driver places his arm on the armrest. The arithmetic device 80 and the display control device 40 are disposed inside of an instrument panel 50 and is not visible from a vehicle compartment.

The display device 20, the vehicular touch pad 30, and the display control device 40 may be coupled with each other in any coupling manner. For example, they may be coupled with each other through a vehicle network communication cable, may be coupled with each other through individual cables, or may be coupled with each other through a wireless communication.

In at least two planes provided in the capacitive sensor panel 70, which will be described later, a plane 130 having shorter linear distance to the design panel 60 is disposed closer to the driver compared with a plane 140 or 150 having longer linear distance to the design panel 60. The plane 130 having shorter linear distance to the design panel 60 is also referred to as “first plane”, and the plane 140 or 150 having longer linear distance to the design panel 60 is also referred to as “second plane”.

The following will describe the vehicular touch pad 30 according to the present embodiment with reference to FIGS. 2 and 3 in detail. FIG. 2 is a perspective view of the vehicular touch pad 30 according to the present embodiment. The design panel 60 is disposed on a front surface of a housing 90 in which the capacitive sensor panel 70 is disposed. On the design panel 60, a touchless operable area 100 that outputs a three-dimensional signal, a touch manipulation area 110 that accepts a touch input, and a determination input area 120 that accepts an input by touch or depression are shown in different colors so as to be easily understood by the driver.

The capacitive sensor panel 70 according to the present embodiment is configured by bending a single capacitive sensor panel in a stepped shape. The capacitive sensor panel 70 bent in the stepped shape is disposed inside of the housing 90. The capacitive sensor panel 70 may be configured by a capacitive sensor sheet bent in the stepped shape.

In the housing 90 and the design panel 60 according to the present embodiment, at least a part corresponding to the determination input area 120 is configured to be touched and depressed by a manipulation body so as to be deformable in a vertical direction. Any configuration deformable in the vertical direction may be applied. For example, a part of the housing 90 corresponding to the determination input area 120 may be equipped with a sliding mechanism (not shown) which is deformable when pressed in the vertical direction, and a part of the design panel 60 corresponding to the sliding mechanism may be separated from the remaining part of the design panel 60. An upper end surface of the housing 90 may be formed of an elastically deformable member such as urethane foam, and the design panel 60 may be made of a deformable material such as a plastic sheet or a synthetic leather.

FIG. 3 is a perspective view illustrating the housing 90 transparentized except for only an outer flame for showing an internal structure of the vehicular touch pad illustrated in FIG. 2. The capacitive sensor panel 70 bent in the stepped shape is disposed below the design panel 60, and includes at least two planes (three planes 130, 140, 150 will be described as an example in the present embodiment) having different distances to the design panel 60.

FIG. 4 is a cross-sectional view schematically illustrating a range of an area (an area in which a distance to the manipulation body can be detected with high accuracy, not applicable to the regions A and B in FIG. 8) in which the manipulation body can be excellently detected in the vehicular touch pad illustrated in FIG. 2. A detection area (proximity detection area 130a) of the plane 130 having shortest distance to the design panel 60 largely exceeds a height of the design panel 60. A detection area (touch detection area 140a) of the plane 140 having longer distance to the design panel 60 than the plane 130 is set to be smaller in the amount exceeding the design panel 60 than the proximity detection area 130a, and slightly exceeds a front surface of the design panel 60. In addition, a detection area (depression detection area 150a) of the plane 150 having longest distance to the design panel 60 is set not to exceed the design panel 60.

The arithmetic device 80 of the vehicular touch pad 30 estimates or determines, according to the magnitude of electric charge stored between the respective three planes 130, 140, 150 and the manipulation body, a proximity degree between the manipulation body and the design panel 60, a position of the manipulation body with respect to the design panel 60, whether the manipulation body touches the design panel 60 or not, and whether determination input manipulation is conducted or not.

At least two planes (three planes 130, 140, and 150 are described as an example in the present embodiment) provided in the capacitive sensor panel are configured by bending a single capacitive sensor panel in a stepped shape. As a result, the touch pad according to the present disclosure can be realized with low cost as compared with a case in which the two planes are configured with the use of multiple individual capacitive sensor panels. In the capacitive sensor panel bent in the stepped shape, because areas of planes perpendicular to the design panel 60 are smaller than areas of planes parallel to the design panel 60, an adverse effect of the electric charge stored in the planes perpendicular to the design panel 60, that is, the planes forming vertical portions of the stepped shape can be reduced.

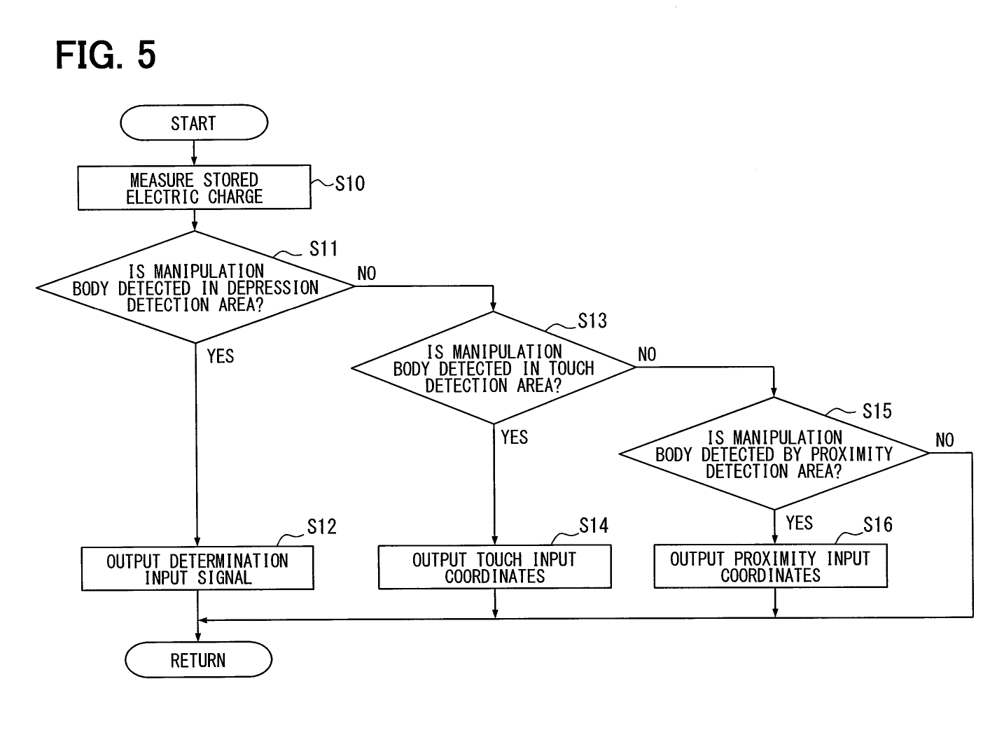

Specifically, the proximity degree of the manipulation body and the design panel 60, the position of the manipulation body to the design panel 60, whether the manipulation body touches the design panel 60 or not, and whether the determination input manipulation is conducted or not, are estimated or determined according to a flowchart illustrated in FIG. 5.

First, in step S10, the electric charge stored in the respective planes 130, 140, and 150 of the capacitive sensor panel 70 is measured, and the process proceeds to step S11.

In step S11, it is determined whether the manipulation body is detected in the depression detection area 150a corresponding to the plane 150 longest in the distance to the design panel 60. When a positive determination is made in step S11, the process proceeds to step S12. When a negative determination is made in step S11, the process proceeds to step S13.

In step S12, a determination input signal is output to the display control device 40 assuming that the determination input area 120 is depressed by the manipulation body.

On the other hand, in step S13, it is determined whether the manipulation body is detected in the touch detection area 140a corresponding to the plane 140 longer in the distance to the design panel 60 than the plane 130 or not. When the positive determination is conducted in step 13, the process proceeds to step S14, and when the negative determination is conducted, the process proceeds to step S15.

In step S14, it is determined that the manipulation body touches the touch manipulation area 110, and coordinates (touch input coordinates) of the manipulation body on the design panel 60 corresponding to the plane 140 are estimated. Then, a signal indicative of the estimated coordinates is output to the display control device 40.

On the other hand, in step S15, it is determined whether the manipulation body is detected in the proximity detection area 130a corresponding to the plane 130 shortest in the linear distance to the design panel 60 in the three planes or not. When the positive determination is conducted in step S15, the process proceeds to step S16, and when the negative determination is conducted, the process returns to step S10.

In step S16, it is determined that the manipulation body approaches closer to the design panel 60, and the proximity degree between the manipulation body and the design panel 60 and the coordinates of the manipulation body on the design panel 60 corresponding to the plane 130 are estimated. Then, a signal indicative of proximity input coordinates which is a three-dimensional signal is output to the display control device 40.

According to the above flowchart, when the arithmetic device 80 determines that the manipulation body touches the design panel 60 on the basis of the electric charge stored in the plane 140 having longer linear distance to the design panel 60, the arithmetic device 80 does not estimate the proximity degree between the manipulation body and the design panel on the basis of the electric charge stored in the plane 130 having shorter linear distance to the design panel 60. With the above configuration, the distance between the manipulation body and the design panel 60 can be restrained from being erroneously detected by the plane 130 having shortest linear distance to the design panel 60 although the manipulation body has already touched the design panel 60.

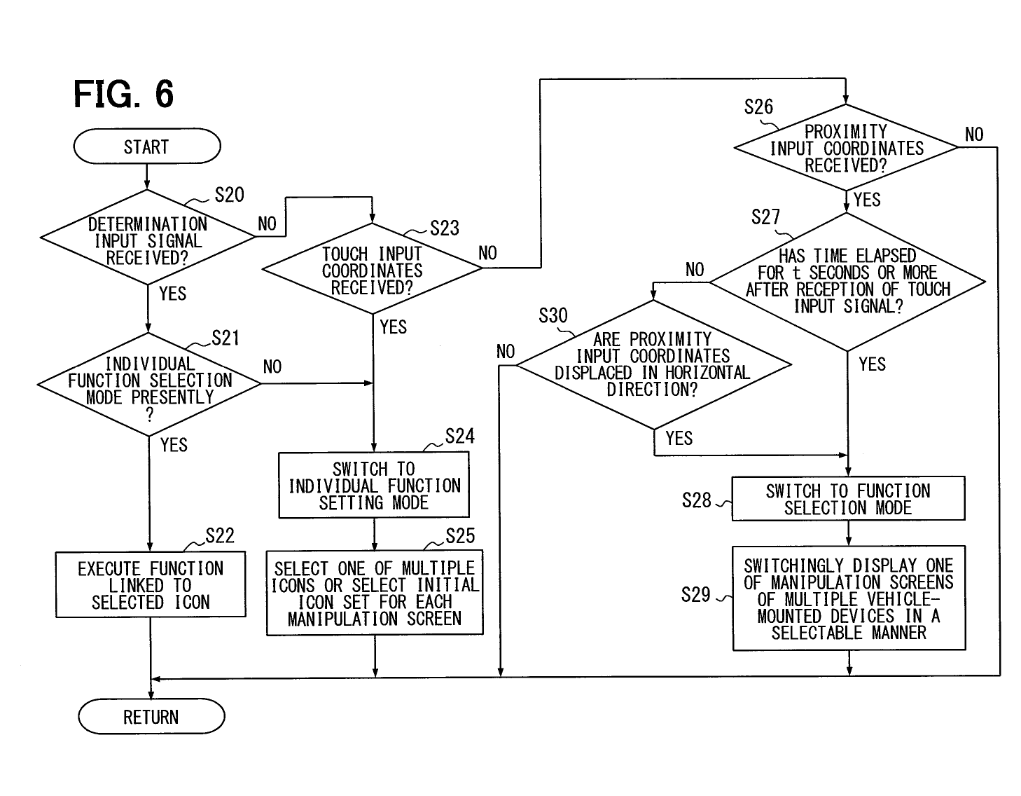

Then, a process in which the display control device 40 controls an image displayed on the display device 20 on the basis of the signal output from the arithmetic device 80 of the touch pad 30 will be described with reference to FIG. 6.

First, in step S20, it is determined whether the determination input signal is received from the arithmetic device 80 or not. When the positive determination is conducted in step S20, the process proceeds to step S21.

In this example, the display device 20 provided by a multifunction display has two display modes including a “function selection mode” and a “individual function setting mode”. The function selection mode is a mode for switching functions such as various manipulation screens and the around view display described above from one to another. The individual function setting mode is a mode for selecting one of multiple icons for conducting specific setting inputs in the respective functions.

In step S21, it is determined whether the display device 20 presently operates in the individual function selection mode. When the positive determination is conducted in step S21, the process proceeds to step S22, and when the negative determination is conducted, the process proceeds to step S24.

In step S22, a function program for performing various settings linked to the icon selected when receiving the determination input signal from the arithmetic device 80 is executed.

On the other hand, when the negative determination is conducted in step S20 or step S21, the process proceeds to step S23. In step S23, it is determined whether a signal indicative of the touch coordinates is received from the arithmetic device 80 or not. When the positive determination is conducted in step S23, the process proceeds to step S24.

In step S24, the display device 20 is allowed to switch to the individual function selection mode regardless of any current mode of the display device 20, and the process proceeds to step S25.

In step S25, one of the multiple icons displayed on the manipulation screen is selected according to a displacement direction of the touch input coordinates on the basis of a temporal transition of the touch input coordinates. In this situation, when the display control device 40 has not yet received a signal indicative of the touch coordinates, the display control device 40 may select a predetermined icon predetermined for each manipulation screen as an initial icon.

When the negative determination is conducted in step S23, the process proceeds to step S26. In step S26, it is determined whether a signal indicative of the proximity input coordinates which is a three-dimensional signal is received from the arithmetic device 80 or not. When the positive determination is conducted in step S26, the process proceeds to step S27.

In step S27, it is determined whether a predetermined time t (for example, 1 second) or more elapses after a time at which the touch input signal has been finally received or not.

When the positive determination is conducted in step S28, the process proceeds to step S28, and the display device 20 is allowed to switch to the function selection mode. In subsequent step S29, one of the manipulation screens of the multiple vehicle-mounted devices sequentially displayed on the display device 20 is selected in the function selection mode according to the displacement direction of the proximity input coordinates.

On the other hand, when the negative determination is conducted in step S27, the process proceeds to step S30, and it is determined whether the proximity input coordinates is displaced in a lateral direction of the vehicle or not. When the proximity input coordinates change, that is, when the manipulation body moves back and forth in the lateral direction within the proximity detection area 130a, the process proceeds to step S28. If not so, the process returns to step S20.

With the execution of the above control, the display control device 40 displays the function selection mode when the manipulation body approaches closer to the design panel 60 without touch on the design panel 60, and controls the display device 20 to display images so as to accept a selection of one of the manipulation screens corresponding to the multiple vehicle-mounted devices according to the displacement of the position of the manipulation body relative to the plane 130. When the manipulation body touches the design panel 60, the display control device 40 switches to the individual function setting mode for the manipulation screen selected at that time, and can control the display device to display an image so as to select any icon according to the displacement of the position of the manipulation body relative to the plane 140. The display control device 40 can switch the manipulation screens of the multiple vehicle-mounted devices from one to another by touchless manipulation without touching the touch pad 30, and perform an input to an intended manipulation screen with touch manipulation on the touch pad 30.

Preferably, after the display control device selects any one of the multiple icons by the determination in step S27 in the individual function setting mode, when the manipulation body moves away from the design panel 60, the display control device does not easily switch from the individual function setting mode to the function selection mode until a predetermined time elapses. On the other hand, the display control device may conduct the switching from the function selection mode to the individual function setting mode without waiting for a predetermined time when the manipulation body touches the design panel. With the above configuration, in the individual function setting mode, a manipulation time necessary for the manipulation body moves away from the design panel 60 and performs a determination input is obtained after one of the multiple icons is selected.

More preferably, in the function selection mode, the display control device 40 controls the image displayed on the display device so as to select one of the manipulation screens corresponding to respective vehicle-mounted devices according to the lateral displacement of the position of the manipulation body relative to the plane 130 as shown by the determination in step S30. With this configuration, after the display control device 40 selects any one of the multiple icons in the individual function setting mode, even if the manipulation body moves away from the design panel 60, the display control device 40 does not switch from the individual function setting mode to the function selection mode until the position of the manipulation body relative to the plane 130 is displaced in the lateral direction. Thus, until the manipulation body moves back and forth in the lateral direction of the vehicle, a manipulation time necessary for performing the determination input can be secured after selecting any one of the multiple icons in the individual function setting mode.

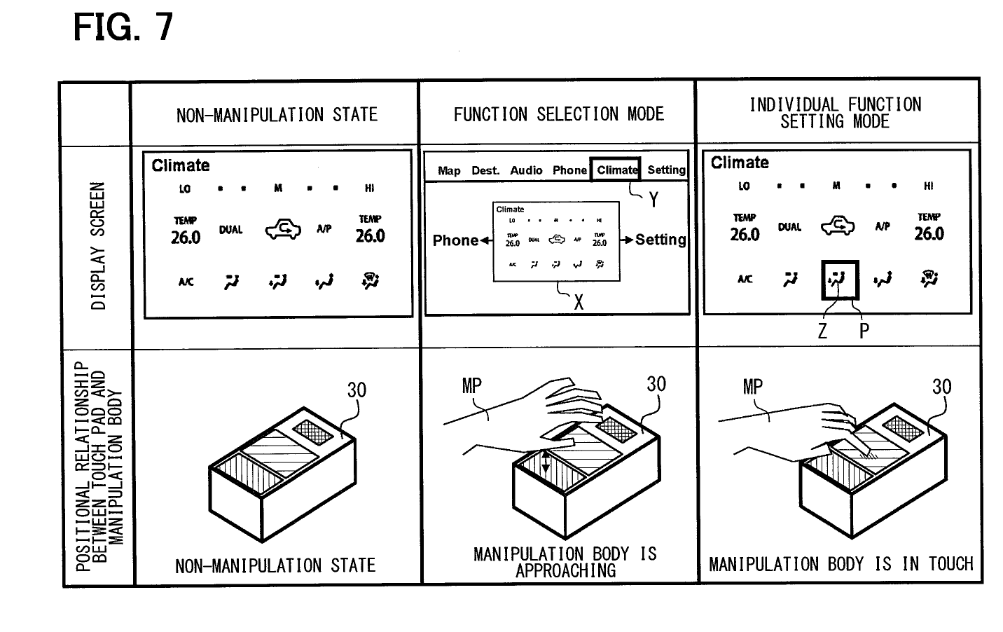

FIG. 7 is a diagram illustrating examples of the display screen of the display device 20 in two display modes, and a positional relationship between the manipulation body (MP) and the vehicular touch pad 30 corresponding to the respective modes in the present embodiment.

A display screen shown in the center portion of FIG. 7 illustrates an example of the display screen of the display device 20 in the function selection mode of the present embodiment. In a graphic user interface (GUI) of the function selection mode according to the present embodiment, names indicative of the respective functions are aligned laterally at a top of the screen, and a manipulation screen X corresponding to a currently selected function is displayed in a reduced size at an approximate center portion of the screen. When the manipulation body touchlessly moves back and forth in the lateral direction of the vehicle in a state where the manipulation body comes closer to the touch pad 30, the manipulation screen X is scrolled in the lateral direction according to the movement of the manipulation body. A highlighting frame Y indicative of the name corresponding to the presently selected function is displayed in a name group at the top of the screen.

The display screen illustrated on a right side of FIG. 7 shows an example of the display screen of the display device 20 in the individual function setting mode according to the present embodiment. Specifically, in the example shown in FIG. 7, a setting screen of a vehicle air conditioning apparatus is displayed. In the GUI of the individual function setting mode according to the present embodiment, multiple icons for setting the individual functions are displayed side by side. When the manipulation body moves under a touch state with the touch pad 30, a display frame P indicative of a selected icon Z moves according to the movement of the manipulation body relative to the touch pad 30.

The display screen illustrated on a left side of FIG. 7 shows a display example during non-manipulation state in which the manipulation body approaches closer to the touch pad 30 but does not touch the touch pad 30 in the present embodiment. The display screen displays the setting screen where a previous individual function is set during non-manipulation state. The switching between the function selection mode and the individual function setting mode may be performed so that the switching between those two modes is easily intuitively understood for the driver by a morphing process such as scaling of the manipulation screen.

### Advantages of the Embodiment

According to the configuration described above, the capacitive sensor panel has at least two planes having different distances to the design panel. The arithmetic device estimates the proximity degree between the manipulation body and the design panel and the position of the manipulation body relative to one plane having shorter linear distance to the design panel on the basis of the electric charge stored between the one plane having shorter linear distance to the design panel and the manipulation body. The arithmetic device also estimates whether the manipulation body touches the design panel or not on the basis of the electric charge stored between the other plane having longer linear distance to the design panel and the manipulation body. Therefore, the two planes of the capacitive sensor panel can complement, with each other, on the detection characteristic of the manipulation body in a region where the estimation accuracy of the distance is remarkably low. As a result, the touch pad that is capable of detecting the distance to the manipulation body with high accuracy can be provided with the use of the capacitive sensor.

As a result, when the driver moves his hand (manipulation body) toward the touch pad, in a driver's close region corresponding to the plane having shorter linear distance to the design panel, the approach of the driver's hand toward the touch pad can be detected. Further, when the driver further moves his hand and touches the touch pad, in a driver's far region corresponding to the plane having longer linear distance to the design panel, the touch manipulation can be detected. Thus, the detection can be performed with consideration of a driver's natural motion.

The above disclosure includes the following aspects.

According to a first aspect of the present disclosure, a vehicular touch pad is realized by a vehicular touch pad disposed in a vehicle compartment. The vehicular touch pad includes a design panel that configures an outer surface of the touch pad, a capacitive sensor panel disposed below the design panel, and an arithmetic device. The capacitive sensor panel includes at least two planes having different distances to the design panel. The arithmetic device estimates a proximity degree between a manipulation body and the design panel and a position of the manipulation body relative to one plane, which is one of the at least two planes included in the capacitive sensor panel and has a shorter linear distance to the design panel, based on an electric charge stored between the one plane and the manipulation body. The arithmetic device further determines whether the manipulation body touches the design panel based on an electric charge stored between a different plane, which is another one of the at least two planes included in the capacitive sensor panel and has a longer linear distance to the design panel, and the manipulation body.

In the above configuration, the capacitive sensor panel has at least two planes having different distances to the design panel. The arithmetic device estimates the proximity degree between the manipulation body and the design panel, and also estimates the position of the manipulation body relative to the one plane having shorter linear distance to the design panel on the basis of the electric charge stored between the one plane having shorter linear distance to the design panel and the manipulation body. The arithmetic device also estimates whether the manipulation body touches the design panel or not on the basis of the electric charge stored between the other plane having longer linear distance to the design panel and the manipulation body. Therefore, the two planes of the capacitive sensor panel can complement with each other for the detection characteristic of the manipulation body in regions A and B shown in FIG. 8 where the estimation accuracy of the distance is remarkably decreased. As a result, a vehicular touch pad capable of detecting the distance to the manipulation body with high accuracy and capable of outputting the three-dimensional signal can be provided with the use of the capacitive sensor.

Among the at least two planes provided in the capacitive sensor panel of the above vehicular touch pad, one plane having shorter linear distance to the design panel is disposed closer to the driver compared with the other plane having longer linear distance to the design panel.

With the above configuration, when the driver moves his hand (manipulation body) toward the touch pad, it can be detected in a region close to the driver and corresponding to the one plane having the shorter linear distance to the design panel that the driver's hand approaches close to the touch pad, and it can be detected in a region far from the driver and corresponding to the other plane having the longer linear distance to the design panel that the driver further moves his hand and touches the touch pad. For that reason, the detection can be performed with consideration of the driver's natural motion.

In the above touch pad, when the arithmetic device determines that the manipulation body touches the design panel on the basis of the electric charge stored in the other plane having the longer linear distance to the design panel, the arithmetic device does not estimate the proximity degree between the manipulation body and the design panel on the basis of the electric charge stored in the one plane having the shorter linear distance to the design panel.

With the above configuration, the distance between the manipulation body and the design panel can be restrained from being erroneously detected by the plane having the shorter linear distance to the design panel although the manipulation body has already touched the design panel.

In the above touch pad, the at least two planes provided in the capacitive sensor panel are provided by two different portions of a single capacitive sensor panel, and the single capacitive sensor panel is provided by a capacitive sensor sheet bent in a stepped shape.

As a result, the vehicular touch pad according to the present disclosure can be configured with low cost as compared with a case in which the two planes are configured with the use of individual multiple capacitive sensor panels.

In the above vehicular touch pad, when the capacitive sensor sheet is bent in the stepped shape, an area of a plane perpendicular to the design panel is smaller than a total area of planes parallel to the design panel.

As a result, an adverse effect of the electric charge stored in the plane perpendicular to the design panel, that is, the planes forming vertical step portion of the stepped shape can be reduced.

According to a second aspect of the present disclosure, a vehicular input interface operates an image displayed on a display device disposed in a vehicle compartment. The vehicular input interface includes a touch pad having a design panel, and a display control device that controls the image displayed on the display device on the basis of an input from the touch pad. The touch pad further includes a capacitive sensor panel and an arithmetic device. The capacitive sensor panel is disposed below the design panel and includes at least two planes having different distances to the design panel. The arithmetic device, according to an output from the capacitive sensor panel including the at least two planes, estimates a proximity degree between a manipulation body and the design panel and a position of the manipulation body relative to the design panel, and determines whether the manipulation body touches the design panel. The arithmetic device estimates the proximity degree between the manipulation body and the design panel and a position of the manipulation body relative to one plane, which is one of the at least two planes included in the capacitive sensor panel and has a shorter linear distance to the design panel, based on an electric charge stored between the one plane and the manipulation body. The arithmetic device determines whether the manipulation body touches the design panel and estimates a position of the manipulation body relative to a different plane, which is another one of the at least two planes included in the capacitive sensor panel and has a longer linear distance to the design panel, based on an electric charge stored between the manipulation body and the different plane.

The display control device operates the image displayed on the display device based on the proximity degree of the manipulation body relative to the design panel and a determination result of whether the manipulation body touches the design panel.

Similar to the vehicular touch pad according to the first aspect, in the above vehicular input interface, the capacitive sensor panel has at least two planes having different distances to the design panel. The arithmetic device estimates the proximity degree between the manipulation body and the design panel, and estimates the position of the manipulation body relative to the one plane having the shorter linear distance to the design panel on the basis of the electric charge stored between the one plane and the manipulation body. The arithmetic device also estimates whether the manipulation body touches the design panel on the basis of the electric charge stored between the other plane having the longer linear distance to the design panel and the manipulation body. Therefore, the at least two planes of the capacitive sensor panel can complement with each other for the detection characteristics of the manipulation body in regions A and B of FIG. 8 where the estimation accuracy of the distance is remarkably decreased with each other. As a result, the vehicular input interface that is capable of detecting the distance to the manipulation body with high accuracy and outputting the three-dimensional signal can be provided with the use of the capacitive sensor.

Among the two planes provided in the capacitive sensor panel in the touch pad of the vehicular input interface, one panel having the shorter linear distance to the design panel is disposed closer to a driver than the other plane having the longer linear distance to the design panel. With this configuration, similar advantages as those in the above touch pad are obtained.

In the touch pad of the above vehicular input interface, when the arithmetic device determines that the manipulation body touches the design panel on the basis of the electric charge stored in the plane having the longer linear distance to the design panel, the arithmetic device does not estimate the proximity degree between the manipulation body and the design panel on the basis of the electric charge stored in the plane having the shorter linear distance to the design panel. With this configuration, similar advantages as those in the above touch pad are obtained.

In the touch pad of the vehicular input interface, the at least two planes provided in the capacitive sensor panel are provided by different two portions of a single capacitive sensor panel, and the single capacitive sensor panel is provided by a capacitive sensor sheet bent in a stepped shape. With this configuration, similar advantages as those in the above touch pad are obtained.

In the touch pad of the vehicular input interface, in the capacitive sensor panel bent in the stepped shape, an area of a plane perpendicular to the design panel is smaller than a total area of planes parallel to the design panel. With this configuration, similar advantages as those in the above touch pad are obtained.

In the above vehicular input interface, the display control device controls the display device to switch between a function selection mode which displays one of manipulation screens corresponding to respective vehicular devices equipped to a vehicle in a selectable manner and an individual function setting mode which displays the one of the manipulation screens selected in the function selection mode. The display control device displays the function selection mode when the manipulation body approaches close to the design panel without touching the design panel, and controls the image displayed on the display device to enable a selection of the one of the manipulation screens corresponding to respective vehicular devices equipped to the vehicle according to a displacement of the position of the manipulation body relative to the one plane having the shorter linear distance to the design panel. The display control device switches to the individual function setting mode corresponding to the one of the manipulation screens which is selected when the manipulation body touches the design panel, and controls the image displayed on the display device for performing an individual setting to the one of the manipulation screens which is selected according to a displacement of the position of the manipulation body relative to the different plane having the longer linear distance to the design panel.

With the above configuration, the manipulation screens of the respective vehicle-mounted devices can be switched from one to another without touching the touch pad, and can be switched to an input to an intended manipulation screen by touch on the touch pad.

More specifically, in the above vehicular input interface, the display control device controls the display device to display an image including a plurality of icons in the individual function setting mode, and controls the image so that one of the plurality of icons is selected according to the displacement of the position of the manipulation body relative to the different plane having the longer linear distance to the design panel.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

What is claimed is:

1. A vehicular touch pad disposed in a vehicle compartment, comprising:
a design panel that configures an outer surface of the vehicular touch pad;
a capacitive sensor panel disposed below the design panel and including at least two planes having different distances to the design panel; and
an arithmetic device estimating a proximity degree between a manipulation body and the design panel and a position of the manipulation body relative to one plane, which is one of the at least two planes included in the capacitive sensor panel and has a shorter linear distance to the design panel, based on an electric charge stored between the one plane and the manipulation body, wherein the arithmetic device further determines whether the manipulation body touches the design panel based on an electric charge stored between a different plane, which is another one of the at least two planes included in the capacitive sensor panel and has a longer linear distance to the design panel, and the manipulation body.

2. The vehicular touch pad according to claim 1, wherein,
among the at least two planes included in the capacitive sensor panel, the one plane having the shorter linear distance to the design panel is disposed closer to a driver than the different plane having the longer linear distance to the design panel.

3. The vehicular touch pad according to claim 1, wherein,
when the arithmetic device determines that the manipulation body touches the design panel based on the electric charge stored in the different plane having the longer linear distance to the design panel, the arithmetic device does not estimate the proximity degree between the manipulation body and the design panel based on the electric charge stored in the one plane having the shorter linear distance to the design panel.

4. The vehicular touch pad according to claim 1, wherein
the at least two planes included in the capacitive sensor panel are provided by at least two different portions of a single capacitive sensor panel, and
the single capacitive sensor panel is provided by a capacitive sensor sheet bent in a stepped shape.

5. The vehicular touch pad according to claim 4, wherein,
in the capacitive sensor sheet bent in the stepped shape, an area of a plane perpendicular to the design panel is smaller than a total area of planes parallel to the design panel.

6. A vehicular input interface for operating an image displayed on a display device disposed in a vehicle compartment, the vehicular input interface comprising:
a touch pad including a design panel; and
a display control device controlling the image displayed on the display device based on an input from the touch pad, wherein
the touch pad further includes:
a capacitive sensor panel disposed below the design panel and including at least two planes having different distances to the design panel; and
an arithmetic device, according to an output from the capacitive sensor panel including the at least two planes, estimating a proximity degree between a manipulation body and the design panel, estimating a position of the manipulation body relative to the design panel, and determining whether the manipulation body touches the design panel,
the arithmetic device estimates the proximity degree between the manipulation body and the design panel and a position of the manipulation body relative to one plane, which is one of the at least two planes included in the capacitive sensor panel and has a shorter linear distance to the design panel, based on an electric charge stored between the one plane and the manipulation body,
the arithmetic device determines whether the manipulation body touches the design panel and estimates a position of the manipulation body relative to a different plane, which is another one of the at least two planes included in the capacitive sensor panel and has a longer linear distance to the design panel, based on an electric charge stored between the manipulation body and the different plane, and
the display control device operates the image displayed on the display device based on the proximity degree of the manipulation body relative to the design panel and a determination result of whether the manipulation body touches the design panel.

7. The vehicular input interface according to claim 6, wherein,
among the at least two planes included in the capacitive sensor panel, the one plane having the shorter linear distance to the design panel is disposed closer to a driver than the different plane having the longer linear distance to the design panel.

8. The vehicular input interface according to claim 6, wherein,
when the arithmetic device determines that the manipulation body touches the design panel based on the electric charge stored in the different plane having the longer linear distance to the design panel, the arithmetic device does not estimate the proximity degree between the manipulation body and the design panel based on the electric charge stored in the one plane having the shorter linear distance to the design panel.

9. The vehicular input interface according to claim 6, wherein
the at least two planes included in the capacitive sensor panel are provided by at least two different portions of a single capacitive sensor panel, and the single capacitive sensor panel is provided by a capacitive sensor sheet bent in a stepped shape.

10. The vehicular input interface according to claim 9, wherein,
in the capacitive sensor sheet bent in the stepped shape, an area of a plane perpendicular to the design panel is smaller than a total area of planes parallel to the design panel.

11. The vehicular input interface according to claim 6, wherein
the display control device controls the display device to switch between a function selection mode which displays one of manipulation screens corresponding to respective vehicular devices equipped to a vehicle in a selectable manner and an individual function setting mode which displays the one of the manipulation screens selected in the function selection mode,
the display control device displays the function selection mode when the manipulation body approaches close to the design panel without touching the design panel, and controls the image displayed on the display device to enable a selection of the one of the manipulation screens corresponding to respective vehicular devices equipped to the vehicle according to a displacement of the position of the manipulation body relative to the one plane having the shorter linear distance to the design panel, and
the display control device switches to the individual function setting mode corresponding to the one of the manipulation screens which is selected when the manipulation body touches the design panel, and controls the image displayed on the display device for performing an individual setting to the one of the manipulation screens which is selected according to a displacement of the position of the manipulation body relative to the different plane having the longer linear distance to the design panel.

12. The vehicular input interface according to claim 11, wherein
the display control device controls the display device to display an image including a plurality of icons in the individual function setting mode, and controls the image so that one of the plurality of icons is selected according to the displacement of the position of the manipulation body relative to the different plane having the longer linear distance to the design panel.
